(19) United States
(12) Patent Application Publication
(10) Pub. No.: US 2002/0043135 A1
(43) Pub. Date: Apr. 18, 2002

(54) Wrench

(76) Inventor: Hsueh Chin Chang, Taichung City (TW)

Correspondence Address: HSUEH CHIN CHANG, P.O. BOX 63-150, Taichung City, TW

(21) Appl. No.: 09/809,574

(22) Filed: Mar. 13, 2001

(30) Foreign Application Priority Data
Oct. 13, 2000 (TW) 89217927

(51) Int. Cl. B25B 13/28

(52) U.S. Cl. 81/111

(57) ABSTRACT

The present invention discloses a wrench having an opening that fits different sizes of screwing and unscrewing objects such as bolts and nuts, and such wrench comprises a main body having a first clipping member and a second clipping member along the axis of the main body and being disposed on at least one of its ends, the first and second clipping members enclose an opening, and the lateral sides of the enclosed opening is for clipping and driving the external diameter of the bolts or nuts characterized in that the length of the front end of the first clipping member is longer than the that of the second clipping member, and a first blocking recession showing a pair of symmetric obtuse angles is disposed at the lateral side adjacent to the opening. The second clipping member maintains in position of being elastically clipped to the lateral side of the opening, and a second recession having an obtuse angle at its front end, and a restricted positioning portion for adjusting the position with a predetermined angle being disposed at the rear end. A mechanical member for restricting the axial displacement is disposed at the rear end of the restricted positioning portion in order to provide the restriction for position after the axial angle of the clipping for the first clipping member is adjusted. Therefore the size of the opening is changed by the automatic adjustment of axial angle of the second clipping member. By the axial displacement of the mechanical members, it quickly releases or presses against the restricted positioning portion, and thereby attains the effect of fast clipping action for a wrench that fits different size of bolts and nuts.

### BACKGROUND OF THE INVENTION

1. Field of the Invention

The present invention relates to a wrench, and more particularly to a wrench that is easy to operate and its opening is able to fit in different sizes of bolts and nuts.

2. Description of the Related Art

In FIG. 1, it shows a traditional open wrench that has two different opening with dimensions according to the specification of the working object such as a bolt. The two different sized rotary clipping heads (usually one side is odd in number and the other even). Generally, the user has to prepare a set of wrenches with various sizes at a time when he is at work in order to screw or unscrew different bolts and nuts. Therefore, these tools are usually sold as a package. One can imagine how heavy these tools are and how troublesome to carry such package around. Furthermore, when these tools are used, the user has to find the right size wrench first to fit the bolts or nuts, and then screws or unscrews them. When the object is screwed to a certain angle, the user has to take the wrench out from the object, and then start another round by placing the open wrench onto the object again. After many back and forth motions, the users can fix the object in position. It wastes a lot of time, and in particularly it is more troublesome for the deep screwing.

In summation of the above description, the inventor bases on years of his experience in this field to conduct research on a simple-to-use and convenient wrench to solve the problems and break through the bottlenecks of the traditional open wrench structure.

### SUMMARY OF THE INVENTION

The primary objective of the present invention is to provide an open wrench that fits different sizes of bolts and nuts having an improved structure that can accommodate all sizes of bolts and nuts by its open end, such that it is unnecessary to remove the open wrench from the bolts or nuts from time to time in the process of screwing and unscrewing.

Another objective of the present invention is to provide an open wrench that fits different sizes of bolts and nuts having an improved structure that it is not necessary to remove the open wrench from a bolt or a nut and place the wrench back to an original holding angle before it starts to rotate again, and such arrangement makes the operation of screwing and unscrewing easier and simpler.

According to the present invention of an open wrench capable of screwing and unscrewing objects of different sizes, it comprises a main body, and a first clipping member and a second clipping member being separately disposed on at least one end in the axial direction of the main body, and an opening formed by enclosure of the first clipping member and the second clipping member and the lateral side of such opening capable of accommodating the external diameter of the bolts and nuts, characterized in that the front end section of the first clipping member is longer than that of the second clipping member, and a first restricted concession having two obtuse angles separately disposed on the lateral sides adjacent to the opening, and the second clipping member maintains in the position of being elastically clipped to the lateral side of the opening, and a second recession having an obtuse angle at its front end, and a restricted positioning portion for adjusting the position with a predetermined angle being disposed at the rear end, and a mechanical member for restricting the axial displacement is disposed at the rear end of the restricted positioning portion in order to provide the restriction for position after the axial angle of the clipping for the first clipping member is adjusted, and therefore the size of the opening is changed by the automatic adjustment of axial angle of the second clipping member, and by the axial displacement of the mechanical members, it quickly releases or presses against the restricted positioning portion, and thereby attains the effect of fast clipping action for a wrench that fits in different size of bolts and nuts.

To make it easier for our examiner to understand the objective of the invention, its structure, innovative features, and its performance, we use a referred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a three-dimensional diagram of the traditional open wrench.

FIG. 2 is a three-dimensional diagram showing the disassembled parts of a preferred embodiment of the present invention.

FIG. 3 shows a transversal cross-section of a preferred embodiment of the present invention.

FIG. 4 shows a longitudinal cross-section of a preferred embodiment of the present invention.

FIG. 5 is a schematic diagram A showing the motion of a preferred embodiment of the present invention.

FIG. 6 is a schematic diagram B showing the motion of a preferred embodiment of the present invention.

FIG. 7 is a planar illustrative diagram A of a preferred embodiment of the present invention.

FIG. 8 is a planar illustrative diagram B of a preferred embodiment of the present invention.

FIG. 9 is a planar illustrative diagram C of a preferred embodiment of the present invention.

FIG. 10 is a three-dimensional diagram of the disassembled parts of the preferred embodiment of the present invention.

FIG. 11 is a traversal cross-sectional diagram of another preferred embodiment of the present invention.

FIG. 12 illustrates the motion of another preferred embodiment of the present invention.

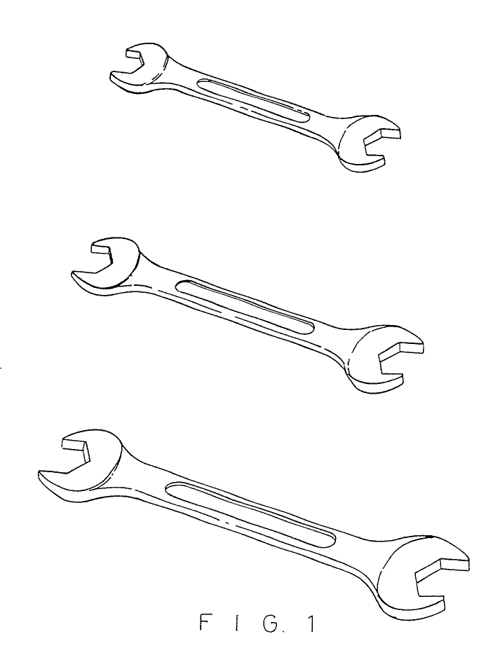

### DETAILED DESCRIPTION OF THE PREFERRED EMBODIMENTS

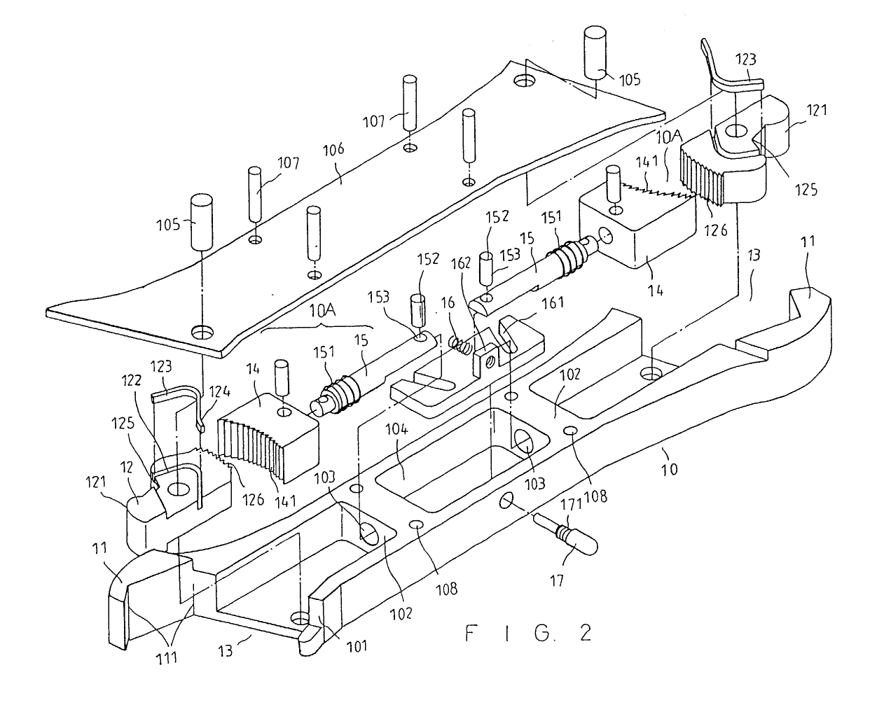

Please refer to FIGS. 2 and 3. The present invention is an open wrench that fits different sizes of screwing and unscrewing objects, comprising a main body 10, and a first clipping member 11 and a second clipping member 12 being disposed at the axial direction of both ends of the main body 10, and the corresponding opposite sides of the two clipping members 11, 12 enclose an opening 13 for accommodating the external diameter of a hexagonal nut 20 or bolt and clipping them to rotate. The first clipping member 11 extends from the main body 10 in a fixed position, and the length of its front end is longer than that of the second clipping member 12. A first restricted concession 111 having two obtuse angles separately disposed on the lateral sides adjacent to the opening 13, and the second clipping member 12 maintains in the position of being elastically clipped to the lateral side of the opening 13 of the main body 10, and the lateral side of its front tip has a circular blocking flange 121 to increase the reliability of the clipping force for clipping the external diameter of bolts or nuts. There is a clipping slot 122 at the side of pivotal interior of the second clipping member 12, which has a U-shaped elastic member 123. The end 124 of the U-shaped elastic member 123 being grasped by the front sidewall 101 of the main body 10 such that the second clipping member 12 constantly leans against the first clipping member 11. There is a second restricted recession 125 having an obtuse-angled opening at the front end of the second clipping member 12. A serrated latch 126 being disposed at the side of the rear end is assembled with the curved surface at the front end of the serrated gear 141 by the serrated latch 126 and a blocking member 14 of the blocking mechanism 10A being assembled to the serrated gear 141 in order to provide a blocking for the positioning after the angle of pivotal expansion of the second clipping member 12. The axial rear end of the blocking member 14 is coupled to a push rod 15, and such push rod 15 passes through the hole 103 of the rib 102 of the main body 10 of the wrench, and the external portion of the push rod 15 being sheathed with a spring 151. Both ends of the spring 151 lie between the sidewall of the rib member 102 and the rear wall of the blocking member 14, and the axial rear end of the push rod 15 being pivotally coupled to a driving member 16. The driving member 16 is disposed in the concave compartment 104 inside the main body 10 of the wrench, and each of its lateral sides has an outwardly inclined driving slot 161, and the internal side of the end of the push rod 15 is disposed on top of the driving member 16, and a bolt 152 passes trough the insert hole 153 of the push rod 15 in such way that the lower portion of the bolt 152 extends into the driving slot 161, and the inclination of the driving slot 161 makes the driving member 16 back and forth and carries the bolt 152 to move accordingly and results in a horizontal displacement for the push rod. The vertical side of the driving member 16 has a protruding ear 162 being coupled to a push button 17, and the push button being exposed to the external wall of the main body 10 of the wrench for us to push. There is a spring 171 being pivotally mounted onto the push button 17 at the axial direction, and the other end of the spring 171 presses against the internal wall of the main body 10 of the wrench.

During assembling, the driving member 16 is installed in the concave compartment 104 of the main body 10 of the wrench first, and the axial rear portion of the push button 17 is sheathed with the spring 171 making the rear end to press against the internal wall of the main body 10 of the wrench. The push rod 15 passes through the hole 103 of the rib member 102 of the main body 10 of the wrench, and the internal side of the push rod 15 is disposed on the upper section of the driving member 16. After using the bolt to passes the push rod 15 into the insert hole 153, the lower portion of the bolt penetrates deeply into the driving slot 161 of the driving member 16, and the other end of the push rod 15 being sheathed with a spring 151, and then the external portion of the push rod 15 is mounted to the blocking member 14. The serrated gear 141 disposed on the external end surface of the blocking member 14 is embedded with the serrated latch 126 at the internal sidewall of the second clipping member 12. The second clipping member 12 is pivotally mounted to the main body 10 of the wrench by an axial post 105 and is being adjacent to the side end of the opening 13. A U-shaped elastic member 123 is being disposed in the clipping slot 122 pivotally mounted on the lateral side of the second clipping member 12 such that the end 124 of the U-shaped elastic member 123 is clipped at the front sidewall of the main body 10 of the wrench and the second clipping member 12 constantly press against the first clipping member 11. A lid panel 106 seals the upper section of the main body 10 of the wrench, and a combined assembly of four bolts 107 passes through the bolt hole 108 of the main body 10 of the wrench to form a whole piece.

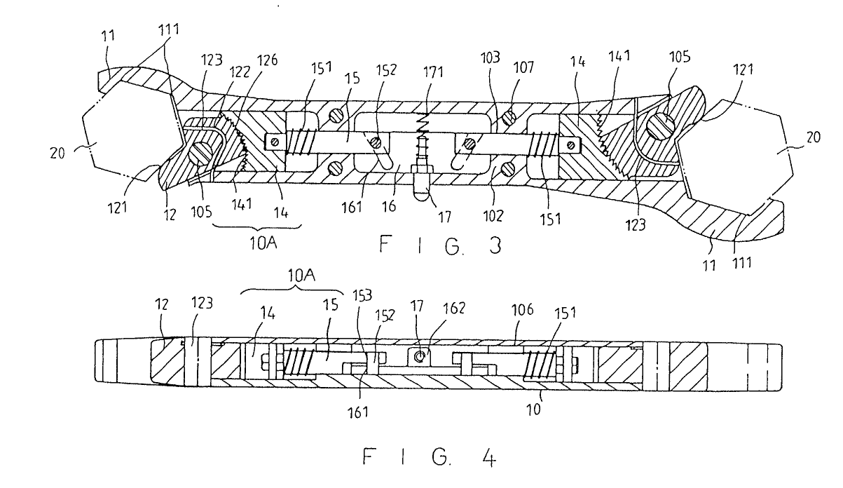

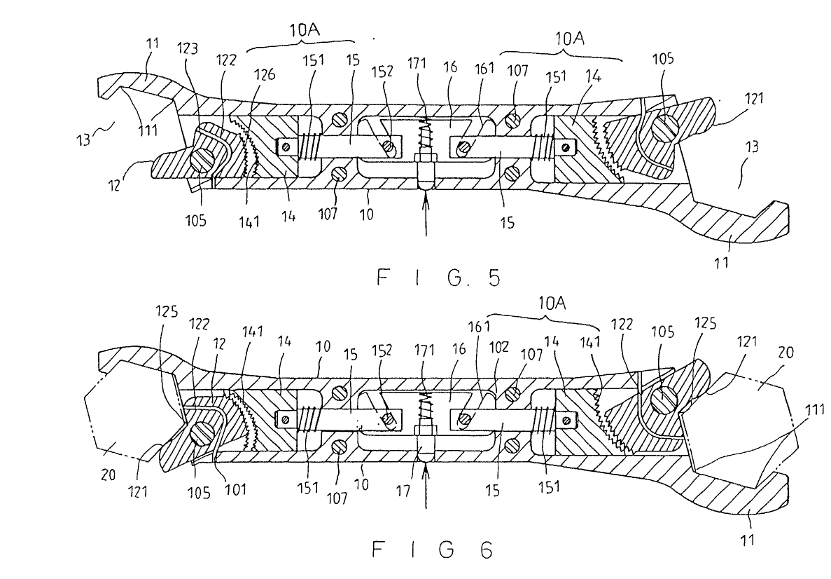

Please refer to FIG. 4 for the application of the wrench according to the present invention. When pressing the push button by a hand, we can push the driving member 16 to displace towards the rear sidewall of the concave compartment 104, and the driving slot 161 makes the push rod 15 and the bolt 152 in its interior to change their positions according to the inclination of the driving slot 161 and to displace towards the middle line of the driving member 16, so that the push rod 15 being coupled to the bolt 152 will be pulled towards the center of the driving member 16. At the meantime, the push rod 15 carries the blocking member 14 to move such that the serrations 141 of the blocking member 14 are separated from the serrated latch 126 of the second clipping member 126, and the second clipping member 12 can freely move back and forth. Therefore, it allows the first clipping member 11 and the second clipping member 12 to accommodate the corresponding opposite sides of a hexagonal bolt or nut 20 and makes the flange 121 of the second clipping member 12 to rotate outward to clip the bolt or nut 20. Furthermore, due to the resuming force given by the U-shaped elastic member 123 in the clipping slot 122 of the second clipping member 12, the wrench can immediately clip the bolt or nut as shown in FIG. 5. Once our hand releases the push button as shown in FIG. 2, then the spring 171 at the rear section of the rod body of the push button 17 immediately resumes the driving member 16 back into the original position. Due to the end of the internal side of the bolt 152 of the push rod 15 follows the moving of the driving slot 161 to move outward, and the spring 151 sheathed on the external side of the push rod 15 will resume and quickly push the blocking member 14 outward and let the serrated gear 141 on the external side of the blocking member 14 quickly embed into the serrated latch 126 of the second clipping member 12. It also fixes the second clipping 12 in position so that it cannot rotate freely.

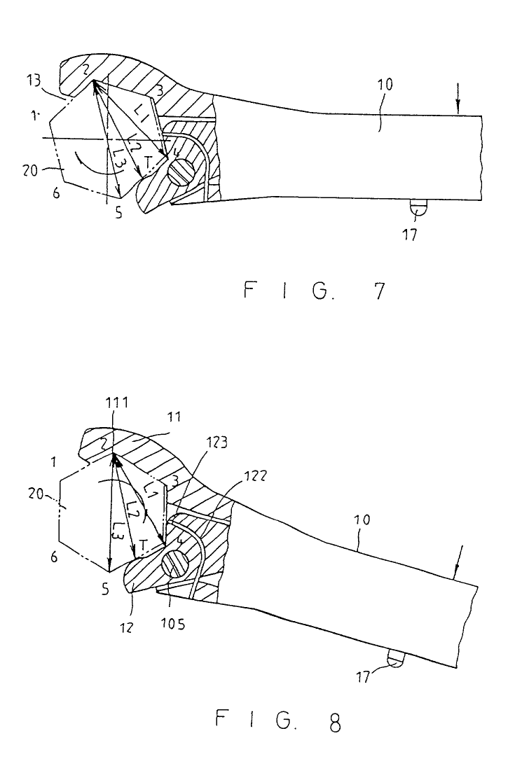

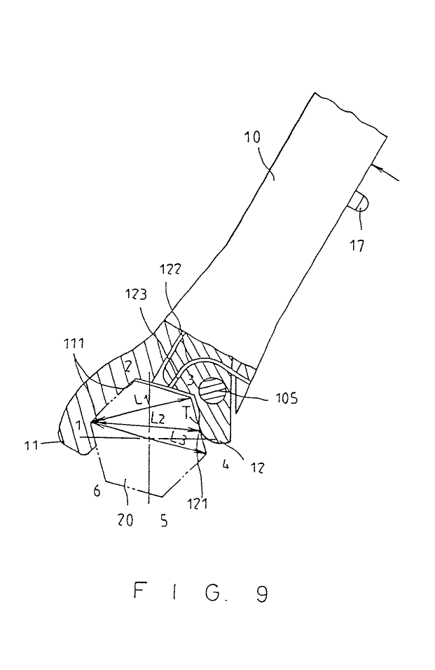

We can rotate the wrench, and the main body will tightly screw or unscrew the bolt or nut 20. Please refer to FIG. 6. When the bolt 20 is rotated in clockwise direction, the flanges 121 of the first clipping member 11 and the second clipping member 12 of the main body 10 of the wrench can tightly attach the corresponding opposite sides of a bolt or nut. Since the distance L1 between the vertex 2 of the bolt 20 to the vertex 4 of the bolt 20 is smaller than the distance L2 between the vertex 2 of the bolt 20 to the tangential contact point T of the flange 121 of the second clipping member 12, and the distance L3 between the vertex 2 of the bolt 20 to the vertex 5 of the bolt 20 is larger than the distance L2 between the vertex 2 of the bolt 20 to the tangential contact point T of the flange 121 of the second clipping member 12, therefore when we rotate the wrench, the opening formed by the corresponding side of the first clipping member 11 and the second clipping member 12 will not slide across the vertex point 2 of the bolt 20 when the wrench rotates clockwise. It will directly drive the bolt 20 to rotate clockwise as shown in FIG. 7. When the wrench is rotate clockwise to a specific angle, the main body 10 of the wrench must return to the original position, therefore the main body 10 can rotate counter-clockwise back to the original angle without driving the bolt 20. It is mainly because the distance L1 is smaller than the distance L2. When the clipping distance (i.e. the distance from vertex 2 to the flange tangential contact point T) of the opening formed by the flanges 121 of the first clipping member 11 and the second clipping member 12 the main body 10 of the wrench is larger than the distance between vertex 2 to vertex 4 of the bolt 20, the tangential contact point T of the flange 121 of the second clipping member 12 can slide across the vertex 4 of the bolt 20 when the wrench is rotated counter-clockwise as shown in FIG. 8. Therefore, when the wrench is rotated backward, it will not carry the bolt to rotate, but slide across the vertices of the bolt 20 and let the main body of the wrench return to the original driving position and allow the different corresponding opposite sides of the bolt lean against the sides of the opening for second round of rotation. Every time when the main body 10 of the wrench returns to its position of original angle, the user needs not to separate the wrench from bolt 20 to continuously perform a clockwise rotation and a counter-clockwise rotation alternatively for screwing or unscrewing a bolt 20 or a nut in a quick manner.

It is worth to mention that the present invention practically can accommodate bolts 20 of different sizes without switching to the other wrench with different sized opening. The structure can clip the corresponding opposite sides of the bolt 20 mainly based on the pivotal coupling of the second clipping member 12 with the main body 10 of the wrench, and by the elastic support of the U-shaped elastic member 123 disposed at its top constantly press the second clipping member 12 towards the first clipping member 11. Even a very small size of the bolt 20 can fit in the open wrench as far as it can be stuck into the opening enclosed by the first clipping member 11 and the second clipping member 12. This key point has broken through the shortcomings of the traditional wrench. Furthermore, the conventional wrench has to fit the size of bolts and nuts, and therefore wrenches of different sizes come with bolts or nuts of different sizes, and the user has to carry lots of wrenches. In addition, the present invention also solves the problem of the convention wrench, which needs to separate wrench from the bolt or nut after the wrench is rotated to a specific angle. The wrench has to put into the bolt or nut again for each round of rotation for the screwing or unscrewing. It has to be done repeatedly and hence wastes lots of time.

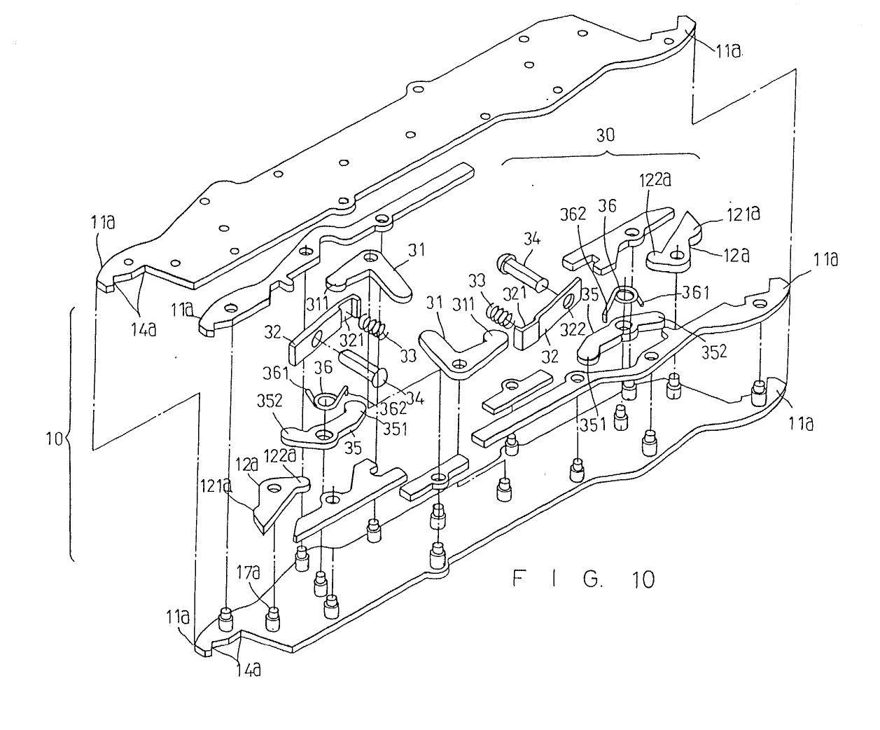

Furthermore, please refer to FIGS. 10 to 12, which introduce another embodiment of the present invention. As shown in the figures, a wrench that fits in different sizes of screwing and unscrewing objects such as bolts and nuts is the same as of the previous example including a main body 10, and a first clipping member 11a and a second clipping member 12a being disposed at the axial direction of both ends of the main body 10, and the corresponding opposite sides of the two clipping members 11a, 12a enclose an opening 13 for accommodating the external diameter of a hexagonal nut 20 or bolt and clipping them to rotate. The slight difference in mechanical parts mainly lies on that the second clipping member 12a is axially coupled to another side of the structure that changes its rear end and extends a rotary arm 122a and converts to another blocking mechanical member 30 as shown in the following embodiment.

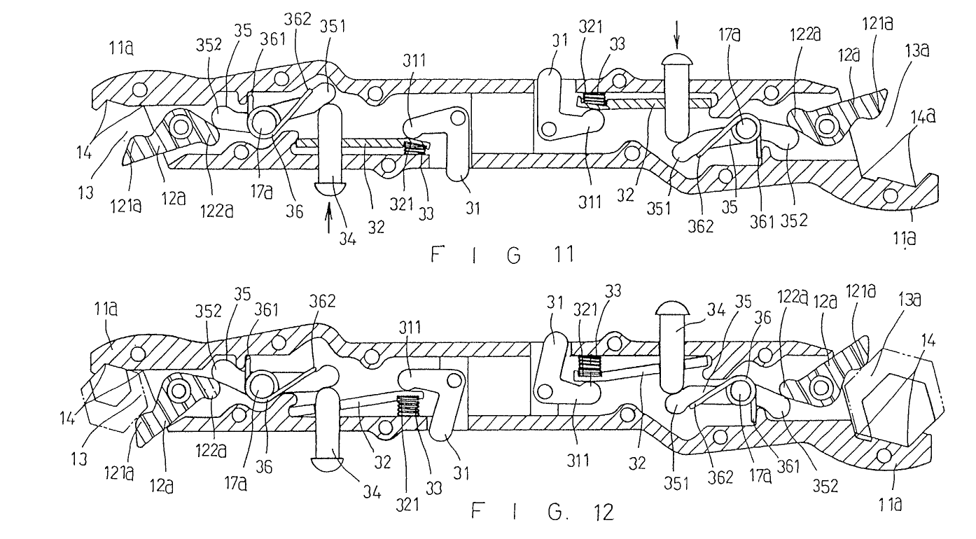

Please refer to FIG. 10 and FIG. 11, of which the blocking mechanical member 30 comprises a hooked button 31 being coupled to the main body 10 for finger pressing. The inner side of the hooked button 31 has a suppressing section 311 to suppress against the lateral end of the backside of a rectangular suppressing board 32, and the suppressing board 32 has an recession 321 on the face to accommodate a spring 33 and press against one end of the spring 33. The other end of the spring 33 presses against the inner wall of the main body 10 of the wrench. The end of the suppressing board 32 proximate to the lateral side of the second clipping member 12a is clipped to the inner wall groove 15a of the main body of the wrench, and a hole 322 being located at the outer end of said suppressing board 32. The front wall of the main body 10 of the wrench corresponding to the position of the hole 322 has a hole 16a for a push rod 34 to pass through, and after such push rod 34 passes through the hole 322 of the suppressing board 32, its end presses against an inner wing 351 of a stopping element 35. Such stopping element 35 is pivotally coupled to the axial post 18a of the main body 10 and the axial post 18a being serially coupled to an elastic member 36. The front end 361 of the elastic member 36 supports the protruding section 18a at the lateral side of the inner wall of the main body 10 or the wrench, and its end 362 presses against the middle of the inner wing 351 of the stopping element 35. The stopping element adjacent to the opening 13a of the main body 10 of the wrench has an outer side wing 352 and makes its sidewall to lean against the edge at the end of a rotary arm 122a extended from the rear side of the second clipping member 12a.

In FIG. 11, by the foregoing structure, the hook button 31 will not be exerted under force, and the suppressing board 32 will prop due to the elasticity of the spring 33, and its inner side end pushes towards the suppressing section 311 of the hooked button 31, but the hole 322 at the external side passes through the end of the pus rod 34, and makes the periphery of the push rod 34 to be fixed to a position and no longer can contract or expand by the slant ringed wall of the hole 322. Therefore, the stopping element 35 propped by the end of the push rod 34 also cannot rotate back freely. In other words, the stopping element 35 is fixed into a position, and the rotary arm 122a of the second clipping member 12a at the front of the outer wing 352 of the stopping element 35 is fixed by the stopping element 35 and not be able to rotate back in the counterclockwise direction. The blocking flange 121a of the second clipping member tightly presses against the screw bolt 20 and it does not allow any extension towards the counterclockwise direction, and hence can clip the hexagonal bolt by the two lateral sides of the wrench.

Please refer to FIG. 12. If we try to enlarge the distance between the second clipping member 12a and the first clipping member 11a in order to facilitate the clipping of a large size bolt, we need to press the hooked button 31 by one hand and let it displace to a side, then the hooked button 31 located inside the suppressing section of the main body 10 of the wrench will be facing and leaning against the inner wall surface of the main body of the wrench, and it will press make the recession 321 of the suppressing board 32 to compress the spring 33. When the suppressing board 32 is in horizontal position, the edge wall of its hole is parallel to the axis of the periphery wall of the push rod 34. When our finger presses the push rod 34 towards the main body, and its end presses against the inner wing 351 of the stopping element 35 thereby the stopping element 35 will rotate back in counterclockwise direction. Then the outer wing 352 of the stopping element 35 suppresses the side wall of the rotary arm 122a at the rear end of the second clipping member 12a and let the second clipping member 12a block the protruding flange 121a moves towards the first clipping member 11a, and hence it can clip the bolts of small size. On the contrary, if one wishes to clip a larger size of bolt, then one should pull the push rod 34 out, and the stopping element 35 will resume its position by the elastic member 35, and its inner wing will rotate to an angle in clockwise direction, and the outer wing will rotate simultaneously in clockwise direction. The second clipping member will extend back outward in clockwise direction by the rotary arm 122a in a distance. Meanwhile, it lets the blocking of the protruding flange 121a extend outward and makes the hexagonal bolt 20 to slide into the opening between the protruding flange and the first clipping member 11a. As soon as the hooked button 31 is released, it immediately props the inner end of the suppressing board 32 by the elastic tension of the spring 33, and supports the suppressing section 311 of the hooked button 31, and tilts the suppressing board 32 to an angle for fixing into the position. The hole 322 of the suppressing board 32 is embedded into the tilted periphery wall and the periphery of the push rod 34, and thereby the push rod 34 is fixed into a position, then the end of the push rod props against the inner wing 351 of the stopping element 35, and makes the outer wing 352 incapable of rotating back in counterclockwise direction. The rotary arm 122a of the second clipping member 12a is latched by the outer wing 352 and not able to rotate back in clockwise direction, such that the second clipping member 12a cannot extend outward, and hence it clips the bolt 20. Hence, it attains the purpose of tightly screwing or unscrewing a bolt and a nut by rotating the main body 10 of the wrench.

It is worth to mention that the second clipping member 12a of the present invention moves towards the first clipping member 11a to adjust the size of the bolt 20. Such operation completely relies on the pushing or pulling of the push rod 34 to control the rotary angle of the outer wing 35 of the stopping element 35. It relatively makes the outer side of the second clipping member 12a blocks the protruding flange 121a and presses it inward with no increments and leans against the first clipping member 11a or extends outward to clip different sizes of bolts 20. Such design can be used in different specification of bolts and nuts, and most importantly it is very simple and easy to operate as well as saving time.

Therefore in summation of the above description, the present invention herein enhances the performance of the conventional wrench structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An open wrench capable of screwing and unscrewing objects of different sizes, comprising a main body, and a first clipping member and a second clipping member being separately disposed on at least one end in the axial direction of the main body, and an opening formed by enclosure of the first clipping member and the second clipping member, and the lateral side of such opening capable of accommodating the external diameter of the bolts and nuts, characterized in that the front end section of the first clipping member is longer than that of the second clipping member, and a first restricted concession having two obtuse angles separately disposed on the lateral sides adjacent to the opening, and the second clipping member maintains in the position of being elastically clipped to the lateral side of the opening, and a second recession having an obtuse angle at its front end, and a restricted positioning portion for adjusting the position with a predetermined angle being disposed at the rear end, and a mechanical member for restricting the axial displacement is disposed at the rear end of the restricted positioning portion in order to provide the restriction for position after the axial angle of the clipping for the first clipping member is adjusted, and therefore the size of the opening is changed by the automatic adjustment of axial angle of the second clipping member, and by the axial displacement of the mechanical members, it quickly releases or presses against the restricted positioning portion, and thereby attains the effect of fast clipping action for a wrench that fits in different size of bolts and nuts.

2. An open wrench capable of screwing and unscrewing objects of different sizes as claimed in claim 1, wherein the rear end of said second clipping member having a restricting section with an unidirectional serrated latch; and said second clipping member having a clipping groove at the middle side of the axis of the second clipping member; an U-shape elastic member being contained in the second clipping member and the end of the U-shape elastic member clips to the front sidewall of the main body of the wrench, such that the second clipping member constantly lean towards the first clipping member; said blocking mechanism comprising a suppressing member for moving the axis back and forth, and the axial rear end of the suppressing member being coupled with a push rod for elastically resuming the axial displacement; a driving lump being coupled to the axial rear end of said push rod, and the driving lump having a driving groove one on each side of the driving lump, and the inner end of the push rod, and a insert latch passing through the insert hole of the insert latch such that the lower section of the insert latch extends into the driving groove, and by means of the inclination of the driving groove the driving lump brings the insert latch to move and pushes the push rod to move horizontally, and a press button being disposed at the middle section of the vertical side of the driving lump, and the outer end of the press button exposes out of the outer wall of the main body of the wrench for users to press, and the press button has a spring on its axial direction, and the other end of such spring props the inner wall of the main body of the wrench, and the front end of the suppressing element is a curved surface, wherein such curved surface having a serrated section corresponding to the restricting section of the serrated gear provides a mutually coupling for the fixing in position of the second clipping member by adjusting the contracting and expanding angle.

3. An open wrench capable of screwing and unscrewing objects of different sizes as claimed in claim 1, wherein the front end of the second clipping member has a blocking flange in the shape of a circular arc being protruded from the front end of the second clipping member to increase the clipping force for securely clipping the external diameter of the bolts and nuts in said opening.

4. An open wrench capable of screwing and unscrewing objects of different sizes as claimed in claim 4, wherein a rotary arm being protruded and extended to the rear end of the second clipping member, and the blocking mechanism comprises a push button coupled to the main body of the wrench for users to press, and the button has a suppressing section to prop the backside of a suppressing board, and the suppressing board is pressed by a spring in its front surface in a tilted position, and the suppressing board has a hole on its other end and another hole being disposed on the corresponding position of the wall of the main body of the wrench, and a push rod being inserted into the hole and passes through the hold on the suppressing board, such that the end of the push rod props a stopping element, and the stopping element being coupled to the axial post of the main body of the wrench, and said axial post being serially coupled to an elastic member for controlling the stopping element to resume its position, and a side wing being disposed at stopping element adjacent to the opening, and said side wing presses against the end of the rotary arm protruded from the rear end of the second clipping member; thereby such arrangement can turn the push button to control the suppressing board to an angle and makes the push rod to contract and expand freely, and allows the stopping element to rotate back to the fixing position in order to transmit the synchronous transition for the second clipping member that can clip bolts of different sizes in position.

5. An open wrench capable of screwing and unscrewing objects of different sizes as claimed in claim 4, wherein a clipping groove being disposed at the inner wall of the main body of the wrench to clip the outer end of the suppressing board, and the inner end of the suppressing board has a recession for accommodating and pressing the front end of the spring.

6. An open wrench capable of screwing and unscrewing objects of different sizes as claimed in claim 4, wherein a protruding section being disposed at an appropriate position on the inner wall of the main body of the wrench for latching the front end of the elastic member, and the rear end of the elastic member latches the middle section of an inner wing of the stopping element, and as the push rod is pulled to resume the stopping element with elasticity to lean against the end of the push rod.
